(19) United States
(12) Patent Application Publication
(10) Pub. No.: US 2009/0228887 A1
(43) Pub. Date: Sep. 10, 2009

(54) FILE MANAGEMENT APPARATUS, FILE MANAGEMENT METHOD, COMPUTER-READABLE MEDIUM AND COMPUTER DATA SIGNAL

(75) Inventor: Shinichiro TANIGUCHI, Tokyo (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/203,705

(22) Filed: Sep. 3, 2008

(30) Foreign Application Priority Data
Mar. 10, 2008 (JP) 2008-059172

(51) Int. Cl. G06F 9/46

(52) U.S. Cl. 718/100

(57) ABSTRACT

A computer-readable medium stores a program that causes a computer to execute a file management process. The process includes: acquiring a process command for process object data; obtaining a data protection method corresponding to process contents specified by the acquired process command; and performing a protection process on the process object data by the obtained protection method.

### CROSS-REFERENCE TO RELATED APPLICATIONS

This application is based on and claims priority under 35 USC 119 from Japanese Patent Application No. 2008-59172 filed Mar. 10, 2008.

### BACKGROUND

1. Technical Field

The invention relates to a file management apparatus, a file management method, a computer-readable medium and a computer data signal.

2. Related Art

A technology for protecting data in a computer system has been known.

A method for protecting data by permitting or inhibiting access to a file or a resource, and a method for protecting data by encrypting and decrypting the data have been known.

However, a technique for changing a data protection method in accordance with contents of a process request to an operation system (OS) has not been known. Therefore, it was not able to protect data flexibly, for example, by changing a data protection method in accordance with an acquiring source or an output destination of data, or by changing a data protection method for each application that uses data.

### SUMMARY

According to an aspect of the invention, a computer-readable medium stores a program that causes a computer to execute a file management process. The process includes: acquiring a process command for process object data; obtaining a data protection method corresponding to process contents specified by the acquired process command; and performing a protection process on the process object data by the obtained protection method.

### BRIEF DESCRIPTION OF THE DRAWINGS

Exemplary embodiments of the invention will be described in detail based on the following figures, wherein:

FIG. 1 is a view showing the configuration of a file management apparatus according to an exemplary embodiment of the invention;

FIG. 2 is a functional block diagram of the file management apparatus according to the exemplary embodiment of the invention;

FIG. 3 is a flowchart of a file managing process according to the exemplary embodiment of the invention;

FIG. 4 is a view showing a registration example of a protection method database according to the exemplary embodiment of the invention;

FIG. 5 is a view showing a registration example of a database that associates safeties with protection methods, according to the exemplary embodiment of the invention;

FIG. 6 is a view showing an example of a database in which timings of processes are registered, according to the exemplary embodiment of the invention;

FIG. 7 is a view showing a registration example of the protection method database according to a modified example 1 of the invention;

FIG. 8 is a view showing a registration example of a database that associates safeties with protection methods, according to the modified example 1 of the invention;

FIG. 9 is a flowchart of a subroutine of a process according to a modified example 2 of the invention; and

FIG. 10 is a view showing a registration example of a protection method database according to the modified example 2 of the invention.

### DETAILED DESCRIPTION

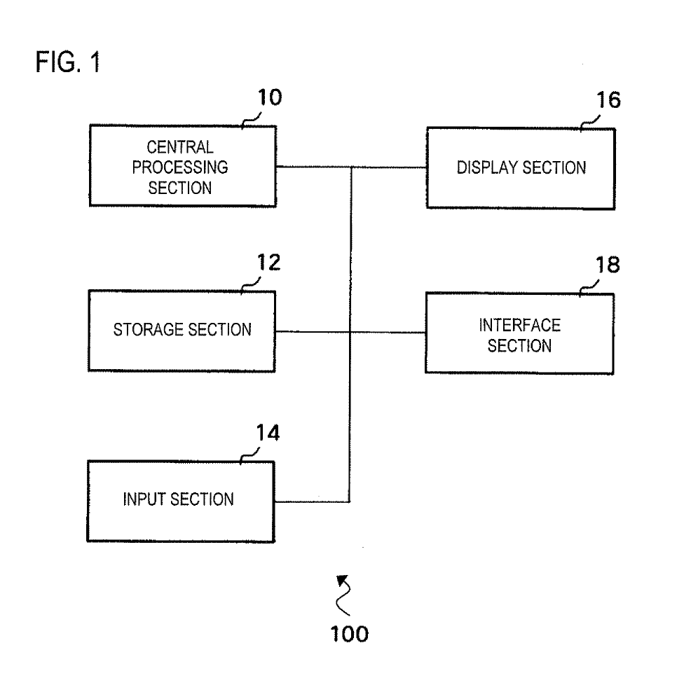

As shown in FIG. 1, a file management apparatus 100 according to an exemplary embodiment of the invention is configured to include a central processing section 10, a storage section 12, an input section 14, a display section 16, and an interface section 18. These sections are connected via an information transmission device such as a bus and a network to transmit/receive information to each other.

The central processing section 10 is configured to include a CPU (central processing unit). The central processing section 10 carries out an information process by receiving information from the storage section 12, the input section 14, and the interface section 18, performing a process, such as a calculation, on the information in accordance with a program, and outputting the processed information to the display section 16 and the interface section 18. In this exemplary embodiment, the central processing section 10 implements functions of the file management apparatus 100 by executing a file management program which is stored in the storage section 12 in advance.

The storage section 12 is configured to include an information storing device such as a semiconductor memory, a hard disk drive and/or an optical disk drive. The storage section 12 stores/holds the file management program to be executed by the file management apparatus 100, a protection method database that will be provided to processes performed in the file management apparatus 100, and various data.

The input section 14 is configured to include a character data input device such as a keyboard, an information input device such as a pointing device, e.g., a mouse, and the like. The input section 14 is operated by a user who inputs information to the file management apparatus 100, and is used to receive a user's instruction and data to be processed. The data input from the input section 14 is stored/held in the storage section 12.

The display section 16 is configured to include a display device. The display section 16 is used to present a user interface image or process object information (information to be processed) to a user during a process executed by application. For example, the display section 16 displays a user interface image that prompts a user to input information necessary for a process performed by the file management device 100.

The interface section 18 is configured to include a device that connects the file management apparatus 100 to another device via a communicating device such as LAN, WAN, the Internet, and the like to send/receive information. In this exemplary embodiment, the file management apparatus 100 can be connected accessibly to an external computer by using the interface section 18. Also, the file management apparatus 100 can output information through an external printer, a facsimile machine, or the like by using the interface section 18. For example, the interface section 18 may be a device that implements information communication in compliance with the existing protocol such as TCP/IP.

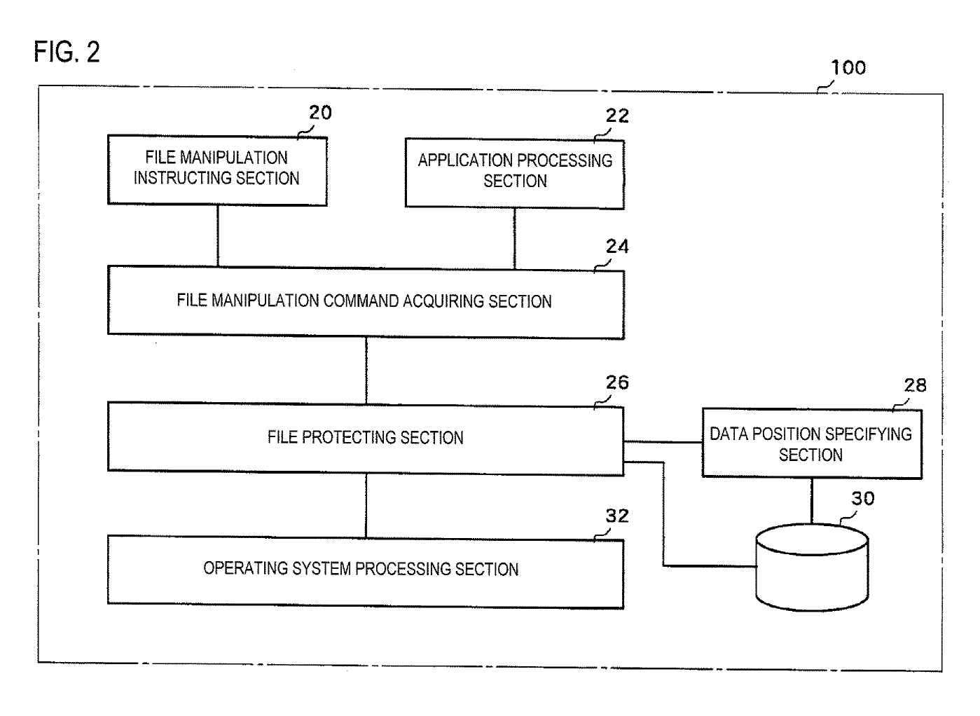

FIG. 2 shows a file management apparatus 100 according to the exemplary embodiment of the invention as a functional block diagram.

As shown in FIG. 2, the file management apparatus 100 functions as an apparatus including a file manipulation instructing section 20, an application processing section 22, a file manipulation command acquiring section 24, a file protecting section 26, a data position specifying section 28, a protection method database storage section 30, and an operating system processing section 32.

### <File Management Process>

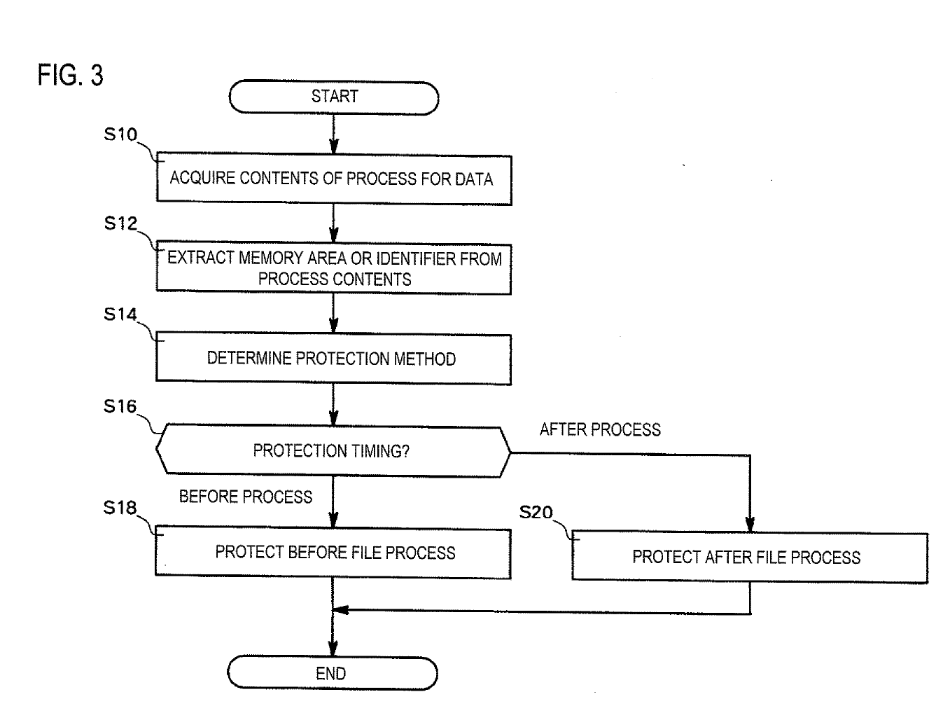

Processes that are executed by the file management apparatus 100 to implement functions shown in the functional block diagram of FIG. 2 will be described below. A file managing process is executed along with a flowchart shown in FIG. 3. The central processing section 10 executes processes from step S10 by executing a file management program stored in the storage section 12.

In step S10, the central processing section 10 acquires a command to specify a process for data (file). The central processing section 10 acquires a process command for the data. The process in this step corresponds to the file manipulation command acquiring section 24. Contents of the acquired process are sent to the file protecting section 26.

Of instructions regarding processes for data, there is one method in which a user directly gives an instruction to the final management apparatus 100 by the input section 14, for example, an instruction for a file manager included in the operating system. This corresponds to the file manipulation instructing section 20. In this case, contents of the process are input from the file manipulation instructing section 20 to the file manipulation command acquiring section 24. Also, there exists another process that application performs on the file management apparatus 100 such as a process to read data required to perform a process contained in the application. This corresponds to the application processing section 22. In this case, contents of the process are input from the application processing section 22 to the file manipulation command acquiring section 24.

Examples of process commands for data include copying of a file (“copy”), moving of a file (“move”), printing of a file (“print”), deleting of a file (“delete”), reading of a file (“read”), writing of a file (“write”), creating of a file (“create”), sending of a file (“send”), and receiving of a file (“receive”).

The copying of a file (“copy”) is a process of reading a file held in a memory area of the storage section 12 while still leaving the file there and then storing the same file in another memory area of the storage section 12. In the file copying (“copy”) process, a memory area of a copy source file and a memory area of a copy destination as well as a copying process command are designated. The moving of a file (“move”) is a process of reading a file held in a memory area of the storage section 12 while not leaving (erasing) the file there and then storing the same file in another memory area of the storage section 12. In the file moving (“move”) process, a memory area of a move source file and a memory area of a move destination as well as a moving process command are designated. The printing of a file (“print”) is a process of converting a file held in a memory area of the storage section 12 or a file being processed in application into an expression format such as postscript, sending the file in this format to a printer, and causing the printer to form an image on a printing medium. In the file printing (“print”) process, a printer used to print as well as a printing process command is designated. The deleting of a file is a process of erasing a file held in the storage section 12. In the file deleting process (“delete”), a memory area in which a file to be deleted is stored and a deleting process command are designated. The reading of a file (“read”) is a process of reading a file held in a memory area of the storage section 12 while still leaving the file there. The read file may be transferred to application or the like, and then a necessary process may be performed thereon. In the file reading (“read”) process, a memory area in which a file to be read is stored and a reading process command are designated. The writing of a file (“write”) is a process of storing a new file created in application into the storage section 12 or the like or storing a file being newly obtained from the interface section 18 or the like into the storage section 12. In the file writing (“writing”) process, a memory area as a storage destination of a file and a writing process command are designated. The creating of a file (“create”) is a process of creating a file based on a command input from a user or a command sent from application. The memory areas designated in the respective processes may be designated as physical memory areas or logical memory areas such as a folder.

For example, a file copying (“copy”) command “copy c¥work¥test.txt c:¥share” includes “copy” indicating a copy command, “c¥work” indicating a copy source memory area, “c:¥share” indicating a copy destination memory area, and “test.txt” indicating a file name.

Also, for example, a file writing (“write”) command “write data c:¥share¥test.txt” includes “write” indicating a write command, “data” indicating data as a writing object, “c:¥share” indicating a writing destination memory area, and “test.txt” indicating a file name of a written data.

Also, a file reading (“read”) command from application includes information for specifying a file as a reading object and an identifier (application name, process name, or the like) for identifying the application. Specifically, “read c:¥work¥test.txt ‘Mail Tool’” includes “read” indicating a read command, “c:¥work” indicating a memory area of a file as the process object, ‘Mail Tool’ indicating that the file is process as an electronic mail, and “test.txt” indicating a file name. Also, another example is “read c:¥work¥test.txt ‘Document Viewer’”. In this example, instead of ‘Mail Tool’ indicating that a file is processed as an electronic mail, ‘Document Viewer’ for displaying contents of a file to present them to a user is designated. Alternatively, “printer A” may be designated to form an image by the designated printer.

In step S12, the central processing section 10 extracts a memory area or an identifier of an output destination from the process contents. The process executed herein corresponds to the file protecting section 26 and the data position specifying section 28. The memory area or the identifier may be contained directly in the process contents or may be acquired indirectly from information contained in the process contents. For example, it is assumed that the process contents include “read c:¥work¥test.txt HANDLE” and that HANDLE is information indicating a read destination memory area. In this case, a process of the read destination is identified from HANDLE. Alternatively, a process of an instruction source of the process command may be used as the read destination.

The central processing section 10 executes the process of extracting a memory area or an identifier for identifying application, which is contained in the process contents, from the process contents acquired in step S10. This corresponds to such a process that the file protecting section 26 sends the process contents acquired in step S10 to the data position specifying section 28 and then, the data position specifying section 28 extracts a memory area or an identifier for identifying application, which is contained in the process contents, and outputs it to the file protecting section 26.

In step S14, the central processing section 10 determines a method for protecting the data (file) in accordance with the process contents. The central processing section 10 refers to a protection method database, which is stored in the storage section 12 in advance, and determines a method for protecting the data (file) in accordance with the process contents acquired in step S10. This process executed herein corresponds to the file protecting section 26 and the protection method database storage section 30.

The protection method database is a database that associates memory areas or identifiers for identifying applications with protection methods. The storage section 12 for storing and holding the protection method database corresponds to the protection method database storage section 30.

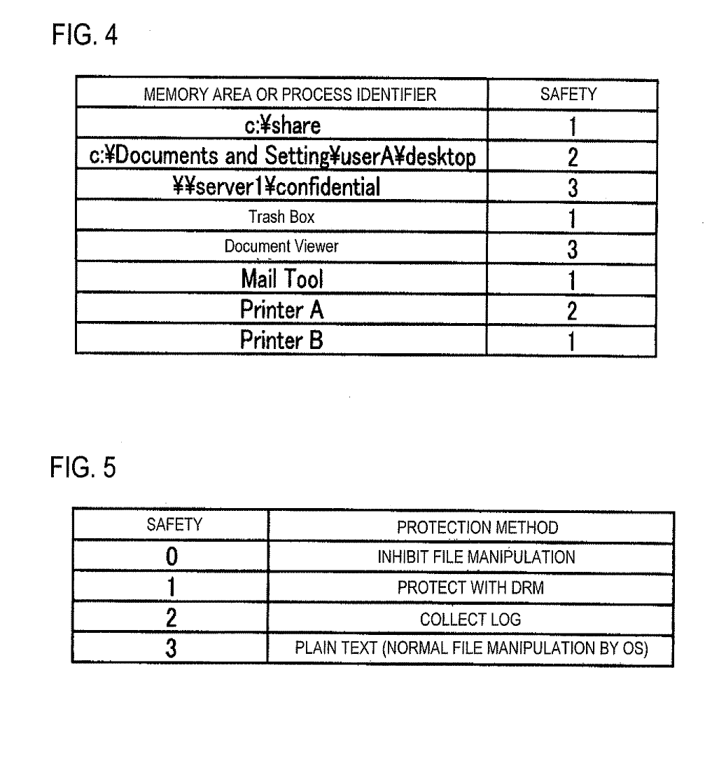

For example, as shown in FIG. 4, a memory area “c:¥share” is associated with a safety “1”, a memory area “c:¥Documents and Setting¥userA¥desktop” is associated with a safety “2”, a memory area “¥¥server1¥confidential” is associated with a safety “3”, and a memory area “Trash box” is associated with the safety “1”. Also, an identifier “Document Viewer” used to identify application is associated with the safety “3”, an identifier “Mail Tool” is associated with the safety “1”, an identifier “Printer A” is associated with the safety “2”, and an identifier “Printer B” is associated with the level safety “1”.

Here, as shown in FIG. 5, a safety “0” means protection by means of prohibition of file manipulation, the safety “1” means protection by means of DRM (Digital Rights Management), the safety “2” means storing of a history (log) of file manipulation, and the safety “3” means permission to perform a process using a plaintext (normal file manipulation by OS).

Here, the safety is set to 0 to 3. However, there is no need that these safeties should indicate a sequence of the safeties or levels of the safeties in protection. Any indicator may be employed so long as it specifies which protection should be applied to data (file) as a process object.

The central processing section 10 accesses the protection method database stored in the storage section 12, and then extracts a safety that is associated with the memory area or the identifier for identifying application, which is contained in the process contents.

This corresponds to such a process that the file protecting section 26, which has received the memory area or the identifier for identifying the application from the data position specifying section 28, refers to the protection method database storage section 30 and extracts a protection method in accordance with the memory area or the identifier for identifying the application.

In step S16, the central processing section 10 determines, for each process content, as to whether the protection is applied to the data (file) before the process is performed (before the process is transferred to the operation system) or the protection is applied to the data (file) after the process is performed (after return from the operation system).

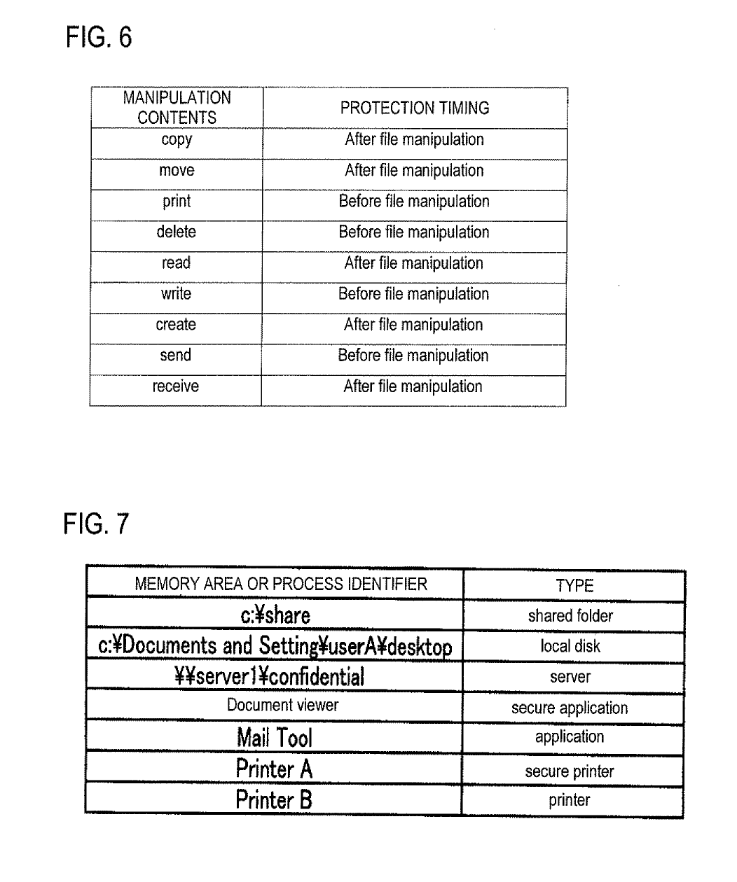

A timing at which the protection is applied to the data (file) is changed in accordance with the process contents. As shown in FIG. 6, in printing of a file (“print”), deleting of a file (“delete”), writing of a file (“write”) and sending of a file (“send”), the protection is applied to data (file) before the data (file) is processed. In this case, the process goes to step S18. In contrast, in copying of a file (“copy”), moving of a file (“move”), reading of a file (“read”), creating of a file (“create”) and receiving of a file (“receive”), the protection is applied to data (file) after the data (file) is processed. In this case, the process goes to step S20.

In step S18, the central processing section 10 applies the protection to the data (file) by the determined protection method. The central processing section 10 applies the protection method determined in step S14 to the data (file) before performing the process specified by the process command, which is acquired for the designated data (file) in step S10. The process mentioned here is executed by the file protecting section 26 and the operating system processing section 32.

For example, when the process contents of “write data c:¥share¥test.txt” are acquired as an instruction to write a file, the protection process is applied to the file before the writing process is performed. After the protection is applied to the acquired file, the central processing section 10 transfers the data “data” as a write object to the operation system, and stores the data “data” in the memory area “c:¥share”, which is a write destination, with a file name “test.txt”. In the example of the protection method database shown in FIG. 4, the safety “1” is assigned to the memory area “c:¥share” of the write destination. Therefore, the central processing section 10 applies the DRM protection to the data “data” before the file is transferred to the operation system.

Here, the “DRM protection” denotes a protection of encrypting contents contained in a file and associating utilization conditions with the contents. In utilizing the file to which the DRM protection is applied, a license containing a decryption key and the utilization conditions is acquired and then, the file is utilized under the utilization conditions. The DRM protection is the common technology, and therefore its detailed explanation will be omitted.

Also, when a process for forming an image by a printer, for example, “print c:¥work¥test.txt ‘printer A’”, is designated, the central processing section 10 applies a protection process a file before the file is output to the printer. The central processing section 10 reads the file specified by the file name “test.txt” from the memory area “c:¥work” in which the file as a process object is stored, applies the protection process to the file, and outputs the file identified by the file name “test.txt” to the printer identified by the identifier “printer A” via the interface section 18. In the example of the protection method database shown in FIG. 4, the safety “2” is assigned to the process “printer A” of the write destination. Therefore, the central processing section 10 executes a process of recording a history of operations applied to the file name “test.txt” in the storage section 12.

With regard to deleting (“delete”) and sending (“send”), a protection process is applied before a file is manipulated, in a similar manner.

In step S20, the central processing section 10 applies the protection to the data (file) by the determined protection method. The central processing section 10 applies the protection method determined in step S14 to the data (file) after performing the process specified by the process command, which is acquired for the designated data (file) in step S10. The process mentioned here is executed by the file protecting section 26 and the operating system processing section 32.

For example, when process contents of “copy c:¥work¥test.txt c:¥share” are acquired as an instruction to copy a file, the protection process is applied to the file after the copying process. The central processing section 10 reads a file identified by the file name “test.txt” from the memory area “c:¥work” of a copy source, and transfers this file to the operation system. The operation system performs the process of copying the file, applies the protection to the copied file, and saves the resultant file in the memory area “c:¥share” of a copy destination with the file name “test.txt”. The safety “1” is assigned to the memory area “c:¥share” of the copy destination in the protection method database. Therefore, the DRM protection is applied to the file, which is stored in the memory area “c:¥share” and has the file name “test.txt”.

Also, when process contents of “read c:¥work¥test.txt ‘Mail Tool’” is acquired from application as an instruction to read a file, the protection process is applied to the file after the reading process. The central processing section 10 reads the file identified by the file name “test.txt” from the memory area “c:¥work” of an object file, applies the protection to the file, and outputs the file to ‘Mail Tool’ as a mailing tool of electronic mails. The safety “1” is assigned to the process “Mail Tool” of the read destination in the protection method database. Therefore, the DRM protection is applied to the file of the file name “test.txt” before the file is output to the process “Mail Tool” and after the reading process.

Similarly, when “Document Viewer” for displaying contents of a file to present the contents to a user is designated, for example, “read c:¥work¥test.txt ‘Document Viewer’”, the protection process is applied to the file after the reading process. The central processing section 10 calls the operation system, reads the file identified by the file name “test.txt” from the memory area “c:¥work” where the file as a process object is stored, and outputs the file to application of the document viewer. The safety “3” is assigned to the process “Document Viewer” of the read destination in the protection method database. Therefore, if the file of the file name “test.txt” is still a plaintext after the reading process, the file is output to the application of the document viewer. In contrast, if the file of the file name “test.txt” is not a plaintext, the file is output to the application of the document viewer after a process of restoring the file into the plaintext.

In this case, when the process of restoring into the plaintext is not permitted on account of the protection conditions in the process of restoring the file into the plaintext, the file may be sent to the application or the like under a protected state. Alternatively, this situation may be handled as a process error or the like. For example, when the DRM protection is applied to an object file and the when protection cancel by a license is not permitted, the file may be still transferred to application in a DRM-protected state.

Also, moving of a file (“move”), creating of a file (“create”) and receiving of a file (“receive”), to which the protection is applied after file manipulation, are similarly processed.

Also, when a memory area or an identifier for identifying application, which is extracted from the process contents, is not registered in the protection method database, a function of the operation system may be applied as it is. For example, a process using a plaintext, to which a safety “3” is assigned, may be applied, or another protection method may be applied. Also, a protection method may be changed depending on process contents of data (file).

### MODIFIED EXAMPLE 1

In the above exemplary embodiment, the protection process is defined for each memory area of a file or each identifier of application for processing a file. In this case, a type may be defined for each memory area of a file or each identifier of application for processing a file, and a protection method may be defined for each type.

Specifically, as shown in FIG. 7, in the protection method database, a memory area “c:øshare” is associated with a type “shared folder”, a memory area “c:øDocuments and Setting¥userA¥desktop” is associated with a type “local disk”, and a memory area “¥¥server1¥confidential” is associated with a type “server”. Also, an identifier “Document Viewer” for identifying application is associated with a type “secure application”, an identifier “Mail Tool” is associated with a type “application”, an identifier “Printer A” is associated with a type “secure printer”, and an identifier “Printer B” is associated with a type “printer”.

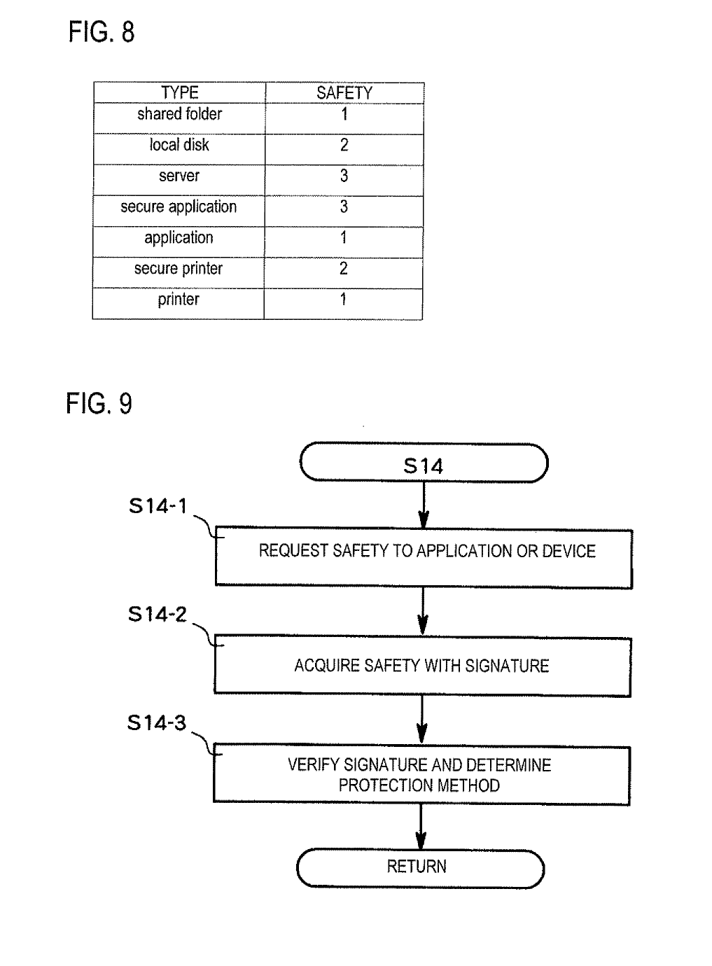

Also, as shown in FIG. 8, in the database that associates types with safeties, the type “shared folder” is associated with the safety “1”, the type “local disk” is associated with the safety “2”, the type “server” is associated with the safety “3”, the type “secure application” is associated with the safety “3”, the type “application” is associated with the safety “1”, the type “secure printer” is associated with the safety “2”, and the type “printer” is associated with the safety “1”.

In this modified example, in step S14, a type allocated to process contents is determined with reference to the protection method database, a safety associated with the determined type is determined, and a protection method for data (file) is determined based on the determined safety. Respective processes subsequent to step S14 are executed similarly to the above exemplary embodiment.

### MODIFIED EXAMPLE 2

In the above exemplary embodiment, the safeties for determining the protection methods are registered in the protection method database in advance. A safety may be acquired from a device or application.

When a safety is acquired from application or a device, such safety should be acquired from application or a device with a signature executed by a trusted third party or a trusted creator.

In this modified example, the above step S14 is performed in accordance with a subroutine shown in FIG. 9. Following processes correspond to a function of the file protecting section 26.

In step S14-1, the central processing section 10 inquires of a device or application, which corresponds to a memory area where a process object is stored, about safety. For example, the device of the inquiry destination is the storage section 12. Also, the application of the inquiry destination may be application which is requested to process a file or is a file output destination.

In step S14-2, the central processing section 10 acquires safety with a signature from the application or the device. Safeties are allocated to respective applications and/or respective devices in accordance with a request in advance, and the respective applications or devices have a function of replying safety, with a signature, allocated in accordance with the request.

In step S14-3, the central processing section 10 verifies the signature acquired in step S14-2, and determines a protection method applied to the file based on the safety when the signature is authentic and the signer is a reliable person. When the signature is not authentic or when the signer is an unreliable person, functions of the operation system may be applied as it is.

When the process in step S14-3 is completed, the process goes back to the process in step S16. The processes subsequent to step S14 are executed similarly to the above exemplary embodiment.

In this case, when a signature key is allocated to the application or the device, an inquiry with a random number may be made in step S14-1, and then a signature containing the random number may be sent back in step S14-2.

Also, when a signature key is not allocated to the application or the device, the safety in which the signature is embedded in advance is sent back. In this case, the signature may be detected based on a Hash value of an executable file of the application or a Hash value of a file of the device driver.

Also, instead of providing the function of replying the safety to the application or the device in response to the inquiry, the central processing section 10 may reads safety contained in an executable file of the application or a file of the device driver.

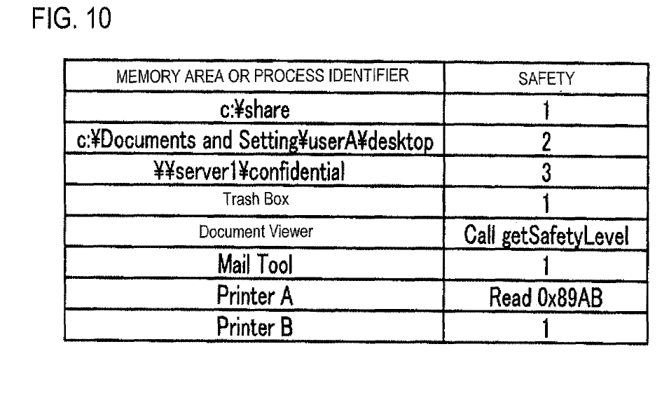

Also, the method of acquiring the safety may be changed depending on application as an output destination of a file or a memory area as an output destination of a file. For example, as shown in FIG. 10, methods for acquiring safeties for memory areas or identifiers of applications and addresses of a memory where the safeties are stored may be registered in advance. Then safety may be acquired by reading therefrom.

For example, in the example shown in FIG. 10, safety for “Document Viewer” is acquired by calling a function of “getSafetyLevel”. Also, safety stored in a memory area identified by a memory address of “0x89AB” is acquired for “Printer A”.

### MODIFIED EXAMPLE 3

In the above exemplary embodiment, the protection method is determined in accordance with the safety of the output destination. A memory area or an identifier of an input source and a memory area or an identifier of an output destination may be extracted from process contents, and then a protection method may be determined based on the safety of the input source and the safety of the output destination. For example, when the protection method database shown in FIG. 4 is provided and when process contents of “copy c:¥share¥doc1.txt c:¥share¥doc2.txt” are executed, copying of a file may be executed as it is without performing the protecting process again because both the input source and the output destination have the same safety. Also, when the safety of the output destination is lower than that of the input source, the process may be prohibited. Conversely, when the safety of the output destination is higher than that of the input source, the protection process may be applied in accordance with the safety of the input source so as not to weaken the protection process as compared with the original protection.

What is claimed is:

1. A computer-readable medium storing a program that causes a computer to execute a file management process, the process comprising:
acquiring a process command for process object data;
obtaining a data protection method corresponding to process contents specified by the acquired process command; and
performing a protection process on the process object data by the obtained protection method.

2. The computer-readable medium according to claim 1, wherein the obtaining obtains the data protection method in accordance with application relating to the acquired process command.

3. The computer-readable medium according to claim 1, wherein the obtaining obtains the data protection method in accordance with an acquiring source or an output destination, which is specified by the acquired process command, of the process object data.

4. The computer-readable medium according to claim 1, wherein the obtaining obtains the data protection method in accordance with a type of the process specified by the acquired process command.

5. The computer-readable medium according to claim 1, wherein the acquiring, the obtaining and the performing are executed between (i) application relating to the acquired process command or an input unit for inputting the acquired process command and (ii) an operation system for performing the protection process on the process object data.

6. The computer-readable medium according to claim 1, wherein the performing performs the protection process on the process object data with switching between (i) before the process specified by the acquired process command is performed on the process object data and (ii) after the process specified by the acquired process command is performed on the process object data, in accordance with the process specified by the acquired process command.

7. A file management apparatus comprising:
a first unit that acquires a process command for process object data; and
a second unit that obtains a data protection method corresponding to process contents specified by the acquired process command, in accordance with the process contents, and performs a protection process on the process object data by the obtained protection method.

8. A file management method comprising:
acquiring a process command for process object data;
obtaining a data protection method corresponding to process contents specified by the acquired process command, in accordance with the process contents; and
performing a protection process on the process object data by the obtained protection method.

9. A computer data signal embodied in a carrier wave for enabling a computer to perform a file management process, the process comprising:
acquiring a process command for process object data;
obtaining a data protection method corresponding to process contents specified by the acquired process command, in accordance with the process contents; and
performing a protection process on the process object data by the obtained protection method.
